(19) United States
(12) Patent Application Publication
(10) Pub. No.: US 2018/0277056 A1
(43) Pub. Date: Sep. 27, 2018

(54) SYSTEM AND METHOD FOR MANAGING IMAGE COLORS

(71) Applicant: MZ IP Holdings, LLC, Palo Alto, CA (US)

(72) Inventor: Kaustubh Atrawalkar, Sunnyvale, CA (US)

(21) Appl. No.: 15/902,168

(22) Filed: Feb. 22, 2018

Related U.S. Application Data
(60) Provisional application No. 62/474,850, filed on Mar. 22, 2017.

(51) Int. Cl. G09G 5/02

(52) U.S. Cl. CPC G09G 5/02; G09G 2320/0666

(57) ABSTRACT

Implementations of the present disclosure are directed to a method, a system, and an article for deriving images of different colors from an original image in an original color. An example computer-implemented method can include: (a) receiving at a client device a first image comprising a first color; (b) shifting the first color of the first image on the client device to create a derived image comprising a new color not present in the first image; (c) presenting the derived image as an element of a graphical user interface on the client device; and (d) repeating steps (b) and (c) to create and present a plurality of derived images comprising a plurality of new colors.

### CROSS-REFERENCE TO RELATED APPLICATIONS

This application claims the benefit of U.S. Provisional Patent Application No. 62/474,850, filed Mar. 22, 2017, the entire contents of which are incorporated by reference herein.

### BACKGROUND

The present disclosure relates to digital images and, in certain examples, to systems and methods for managing image colors for a software application.

In general, a software application can require client devices to display a wide variety of graphical elements in many different colors. Each graphical element and variation thereof is typically delivered as a separate image from a server to each client device running the application, using one or more computer networks (e.g., the Internet). When the number of graphical elements for the software application is large, demands on the server and the computer networks can be excessive, particularly when a large number of client devices (e.g., in the millions) are running the software application and must download and display the multiple images. The client devices are typically required to store the images for the software application, which can increase memory requirements and/or leave less space available for storage on the client devices.

### SUMMARY

In general, the subject matter of this disclosure relates to systems and methods for deriving images of different colors from an original image in an original color. The original image can be uniform in color (e.g., unicolor, with no color gradients) or can include textures (e.g., due to color gradients) that are preferably also present in the derived images. In some instances, an artist or software developer can create an original image of a red button (e.g., for a graphical user interface) for a software application, and the systems and methods described herein can derive images of the same button in blue, green, yellow, or any other color. The derived images can be created on a client device running the software application, preferably without having to separately store the derived images on the client device or transmit any derived images to the client device.

Advantageously, the approach can greatly reduce a total number of images that must be transmitted to and/or stored on a client device (e.g., from a server over a network) to provide a software application on the client device. Compared to previous approaches, for example, the client device can receive and store a single, original image and derive other images for the software application based on the original image. The approach can reduce network traffic, bundle size, parsing time (e.g., for textures), and/or client device storage requirements. This can greatly improve a user's experience with a software application and/or can improve overall performance of the software application, the client device, and a network associated with the client device.

In one aspect, the subject matter described in this specification relates to a method. The method includes: (a) receiving at a client device a first image having a first color; (b) shifting the first color of the first image on the client device to create a derived image having a new color not present in the first image; (c) presenting the derived image as an element of a graphical user interface on the client device; and (d) repeating steps (b) and (c) to create and present a plurality of derived images having a plurality of new colors.

In certain examples, the first image can include a texture having a gradient in color. The plurality of derived images can include the texture. Shifting the first color can include adjusting at least one of a hue, a saturation, and a value in an HSV color space. The first color can be defined in an RGB color space, and shifting the first color can include transforming the first color from the RGB color space to an HSV color space. Shifting the first color can include transforming the new color from an HSV color space to an RGB color space.

In some implementations, the first image can include pixels, and shifting the first color can include applying a color shift to a portion of the pixels in the first image. The element can be selectable by a user of the client device. The method can include removing the derived image from memory on the client device. In various instances, the first image can be received at the client device from a server, and the server can provide support for an application used to perform steps (b), (c), and (d) on the client device.

In another aspect, the subject matter described in this specification relates to a system. The system includes one or more computer processors programmed to perform operations including: (a) receiving at a client device a first image having a first color; (b) shifting the first color of the first image on the client device to create a derived image having a new color not present in the first image; (c) presenting the derived image as an element of a graphical user interface on the client device; and (d) repeating steps (b) and (c) to create and present a plurality of derived images having a plurality of new colors.

In certain examples, the first image can include a texture having a gradient in color. The plurality of derived images can include the texture. Shifting the first color can include adjusting at least one of a hue, a saturation, and a value in an HSV color space. The first color can be defined in an RGB color space, and shifting the first color can include transforming the first color from the RGB color space to an HSV color space. Shifting the first color can include transforming the new color from an HSV color space to an RGB color space.

In some implementations, the first image can include pixels, and shifting the first color can include applying a color shift to a portion of the pixels in the first image. The element can be selectable by a user of the client device. The operations can include removing the derived image from memory on the client device. In various instances, the first image can be received at the client device from a server, and the server can provide support for an application used to perform steps (b), (c), and (d) on the client device.

In another aspect, the subject matter described in this specification relates to a non-transitory computer-readable medium having instructions stored thereon that, when executed by one or more computer processors, cause the computer processors to perform operations including: (a) receiving at a client device a first image having a first color; (b) shifting the first color of the first image on the client device to create a derived image having a new color not present in the first image; (c) presenting the derived image as an element of a graphical user interface on the client device; and (d) repeating steps (b) and (c) to create and present a plurality of derived images having a plurality of new colors.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for creating and displaying images of different colors on a client device.

FIG. 2 is a schematic diagram of an RGB color space, in accordance with certain implementations of this disclosure.

FIG. 3 is a schematic diagram of an HSV color space, in accordance with certain implementations of this disclosure.

FIG. 4 is a schematic diagram of an example method of using an image module to create images of different colors.

FIGS. 5A-5D include an original image and three images derived from the original image, in accordance with certain implementations of this disclosure.

FIG. 6 includes a collection of images of different colors, in accordance with certain implementations of this disclosure.

FIG. 7 is a schematic diagram of a client device displaying images of different colors.

FIG. 8 is a flowchart of an example method of creating and displaying images of different colors on a client device.

### DETAILED DESCRIPTION

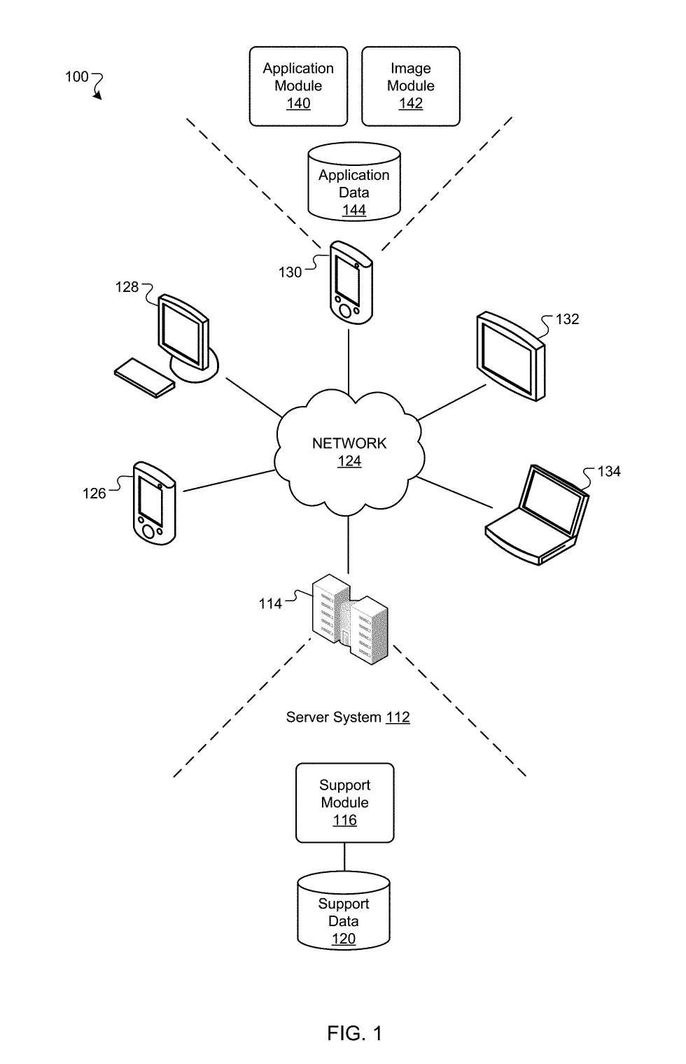

FIG. 1 illustrates an example system 100 for creating images of different colors on a client device. A server system 112 provides functionality for providing a software application to a plurality of users. The server system 112 includes software components and databases that can be deployed at one or more data centers 114 in one or more geographic locations, for example. The server system 112 software components can include a support module 116 and/or can include subcomponents that can execute on the same or on different individual data processing apparatus. The server system 112 databases can include a support data 120 database. The databases can reside in one or more physical storage systems. The software components and data will be further described below.

An application, such as, for example, a web-based or other software application can be provided as an end-user application to allow users to interact with the server system 112. The software application can be accessed through a network 124 (e.g., the Internet) by users of client devices, such as a smart phone 126, a personal computer 128, a smart phone 130, a tablet computer 132, and a laptop computer 134. Other client devices are possible.

Each client device in the system 100 can utilize or include software components and databases for the software application. The software components on the client devices can include an application module 140 and an image module 142. The application module 140 can implement the software application on each client device. The image module 142 can be used to modify and/or create images for the software application. The databases on the client devices can include an application data 144 database which can store data for the software application and exchange the data with the application module 140 and/or the image module 142. The data stored on the application data 144 database can include, for example, user data, image data, video data, and any other data used or generated by the application module 140 and/or the image module 142. While the application module 140, the image module 142, and the application data 144 database are depicted as being associated with the smart phone 130, it is understood that other client devices (e.g., the smart phone 126, the personal computer 128, the tablet computer 132, and/or the laptop computer 134) can include the application module 140, the image module 142, the application data 144 database, and any portions thereof.

Still referring to FIG. 1, the support module 116 can include software components that support the software application by, for example, performing calculations, implementing software updates, exchanging information or data with the application module 140 and/or the image module 142, and/or monitoring an overall status of the software application. The support data 120 database can store and provide data for the software application. The data can include, for example, user data, image data, video data, and/or any other data that can be used by the server system 112 and/or client devices to run the software application. In certain instances, for example, the support module 116 can retrieve image data from the support data 120 database and send the image data to client devices, using the network 124.

The software application implemented on the client devices 126, 128, 130, 132, and 134 can relate to and/or provide a wide variety of functions and information, including, for example, entertainment (e.g., a game, music, videos, etc.), business (e.g., word processing, accounting, spreadsheets, etc.), news, weather, finance, sports, etc. In certain instances, the software application provides a multi-player online game.

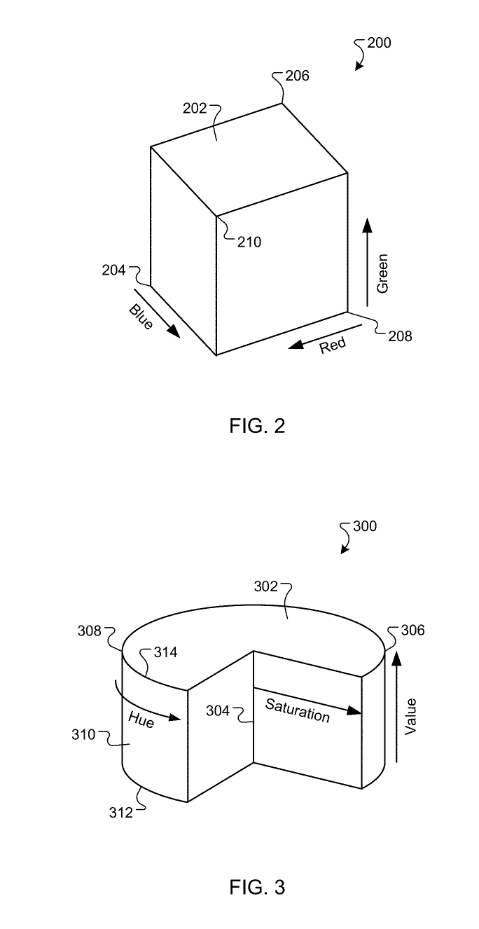

Referring to FIG. 2, an RGB color space 200 can be represented by a cube 202 in which intensities of red (R), green (G), and blue (B) colors vary in directions orthogonal to faces of the cube. The R, G, and B colors can be combined to produce any color within the RGB color space 200. In the depicted example, the colors red, green, blue, and white can be found at corner 204, corner 206, corner 208, and corner 210, respectively. Brightness can be an arithmetic mean of the R, G, and B colors.

Referring to FIG. 3, an HSV color space 300 can be represented by a cylinder 302 in which a hue (H) varies with angular position around a center 304 of the cylinder 302, a saturation (S) varies with radial position from the center 304 of the cylinder 302, and a value (V) varies along a length of the cylinder 302. In general, hue refers to a perceived color (e.g., red, yellow, green, or blue) or a combination of colors. Hue can vary from red at a point 306 to blue-green at a point 308, which can be located 180 degrees from the point 306. Saturation or colorfulness refers to a perceived intensity of color. In the depicted example, the most intense colors exist at an outer surface 310 of the cylinder 302 (where saturation is a maximum) and the least intense colors exist at the center 304 of the cylinder (where neutral, achromatic, or gray colors are located, ranging from black to white). Value refers to a lightness of colors, which can vary from dark at a bottom 312 of the cylinder, where value is a minimum, to light at a top of the cylinder 314, where value is a maximum.

Various methods can be used to transform or convert colors between the RGB color space and the HSV color space. For example, values for H, S, and V can be obtained from R, G, and B values using:

$$\begin{matrix}H = \{ \begin{matrix} 0 ° & , Δ = 0 \\ 60 ° \times ( \frac{G - B}{Δ} mod 6 ) & , {C}_{max} = R \\ 60 ° \times ( \frac{B - R}{Δ} + 2 ) & , {C}_{max} = G \\ 60 ° \times ( \frac{R - G}{Δ} + 4 ) & , {C}_{max} = B\end{matrix} , & ( 1 ) \\ S = \{ \begin{matrix}0 & , {C}_{max} = 0 \\ \frac{Δ}{{C}_{max}} & , {C}_{max} \neq 0\end{matrix} , & ( 2 ) \\ and & \\ V = {C}_{max} , & ( 3 )\end{matrix}$$

where each of R, G, and B varies from 0 to 1, Cₘₐₓ is a maximum of R, G, and B, Cₘᵢₙ is a minimum of R, G, and B, and A is Cₘₐₓ−Cₘᵢₙ. Equations (1), (2), and (3) can produce values for H that vary from 0° to 360° and values for each of S and V that vary from 0 to 1. For example, the following pseudo code can be used to derive H, S, and V values from RGB color space:

vec3 rgb2hsv(vec3 c)
{

vec4 K = vec4(0.0, −1.0 / 3.0, 2.0 / 3.0, −1.0);
vec4 p = mix(vec4(c.bg, K.wz), vec4(c.gb, K.xy), step(c.b, c.g));
vec4 q = mix(vec4(p.xyw, c.r), vec4(c.r, p.yzx), step(p.x, c.r));
float d = q.x − min(q.w, q.y);
float e = 1.0e−10;
return vec3(abs(q.z + (q.w − q.y) / (6.0 * d + e)), d / (q.x + e),
q.x);

} .

Likewise, values for R, G, and B can be obtained from H, S, and V values using:

$$( R , G , B ) = \{ \begin{matrix}( C , X , 0 ) & , 0 ° \leq H \leq 60 ° \\ ( X , C , 0 ) & , 60 ° \leq H \leq 120 ° \\ ( 0 , C , X ) & , 120 ° \leq H \leq 180 ° \\ ( 0 , X , C ) & , 180 ° \leq H \leq 240 ° \\ ( X , 0 , C ) & , 240 ° \leq H \leq 300 ° \\ ( C , 0 , X ) & , 300 ° \leq H \leq 360 °\end{matrix} \qquad ( 4 )$$

where

C=V×S, (5)

X=C×(1−|(H/60°)mod 2−1|), (6)

and each of R, G, and B varies from 0 to 1. For example, the following pseudo code can be used to convert H, S, and V values back to RGB color space:

vec3 hsv2rgb(vec3 c)
{

vec4 K = vec4(1.0, 2.0 / 3.0, 1.0 / 3.0, 3.0);
vec3 p = abs(fract(c.xxx + K.xyz) * 6.0 − K.www);
return c.z * mix(K.xxx, clamp(p − K.xxx, 0.0, 1.0), c.y);

} .

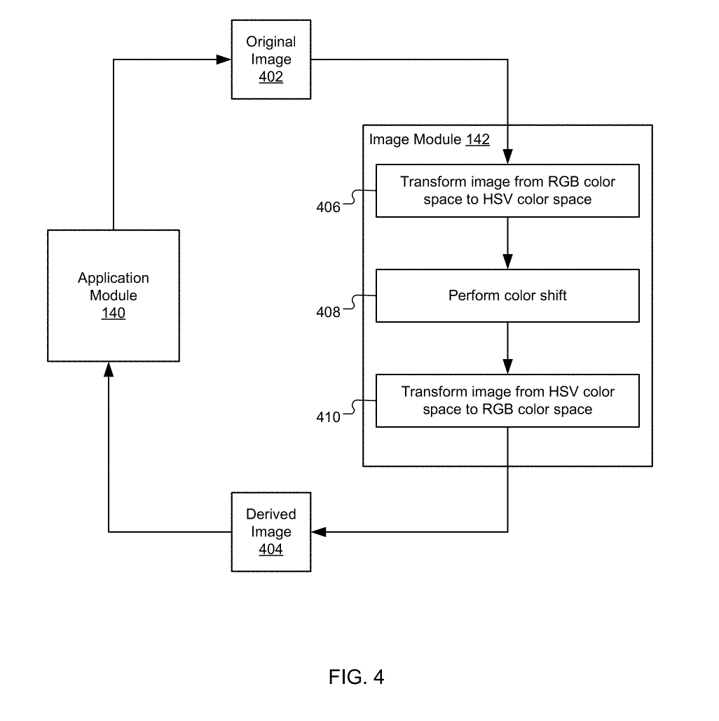

Referring to FIG. 4, in various implementations, the image module 142 can be used to derive images of different colors for a software application running on a client device. The image module 142 can receive an original image 402 from the application module 140 (and/or from the application data 144 database) and perform a color shift to create a derived image 404 that is similar to the original image 402 but preferably in a different color. For example, the derived image 404 can include one or more colors that are not present in the original image 402. In a typical example, the original image 402 can be defined in RGB color space, such that each pixel in the original image 402 can have or be associated with values for R, G, and B. Prior to performing the color shift, the original image 402 is preferably transformed (step 406) from RGB color space to HSV color space. The transformation can be performed by converting the R, G, and B values for each pixel in the original image to corresponding H, S, and V values using, for example, equations (1), (2), and (3).

After transforming the original image 402 to HSV color space, the color shift can be performed (step 408) by adjusting one or more of the H, S, and V values. The adjustment is preferably the same for each pixel in the original image, for example, so that the H, S, and/or V values are adjusted by the same amount for all pixels in the image. In alternative examples, the color shift can be performed for only a portion of the pixels in the original image 402. This can allow one or more discrete areas of the original image 402 to receive the color shift, for example, while other areas can remain unchanged.

After applying the color shift, the resulting derived image 404 is preferably transformed (step 410) from HSV color space back to RGB color space. The transformation can be performed by converting the H, S, and V values for each pixel to corresponding R, G, and B values using, for example, equations (4), (5), and (6). The derived image 404, now defined in RGB color space, can be sent from the image module 142 to the application module 140, which can cause a client device to display the derived image 404. In preferred implementations, the derived image 404 can be displayed on the client device as an element of a graphical user interface and/or can be selected by a user of the client device. To create another derived image 404 in a different color, the image module 142 can repeat steps 406, 408, and 410, while applying a different color shift at step 408. In this way, many different images of different colors can be derived from the single, original image. The application module 140 can cause the derived images to be displayed on the client device (e.g., in a graphical user interface), either separately or simultaneously. In preferred implementations, the derived images are not stored in memory and can be created again, if needed, using the image module 142.

In certain instances, it may not be necessary to convert between the RGB and HSV color spaces. For example, if the original image 402 is initially defined in HSV color space, step 406 can be avoided and the image module 142 can proceed to the color shift at step 408. Additionally or alternatively, it can be preferable to define the derived image 404 in HSV color space, such that there is no need to convert the derived image 404 to RGB color space. This can avoid step 410. In some cases, the color shift can be performed in RGB color space by adjusting one or more of the R, G, and B values. For example, the R and B values can be swapped to convert between red and blue colors. When the color shift is performed in RGB color space, the transformation to HSV color space at step 406 and the transformation back to RGB color space at step 410 can be avoided.

In preferred instances, however, color shifting is preferably performed in the HSV color space. In general, HSV can provide better control over color adjustments and/or can be a more intuitive color space for software designers and developers to implement or define color changes. For example, it can be easier in HSV color space (compared to RGB) to change colors in an image while preserving certain textures or borders that may be present in the image. If an image contains a black border, for example, changing the H values of all pixels by an equal amount will generally preserve the black border. Additionally or alternatively, shifting the H values for all pixels by an equal amount can preserve certain textures that may be present in the image (e.g., due to color gradients or arrangements of gray or black pixels). Another advantage of performing the color shift in HSV color space is that HSV is generally consistent with certain web standards, such as Cascading Style Sheets (CS S) and/or HTML, and software developers can be generally familiar with a syntax used for HSV. In alternative examples, color shifting can be performed in other color spaces, including HSL, CIELUV, CIELAB, CIEUVW, sRGB, CIELCh_{ab}, CIELChᵤᵥ, and/or CMYK. Other color spaces can be used.

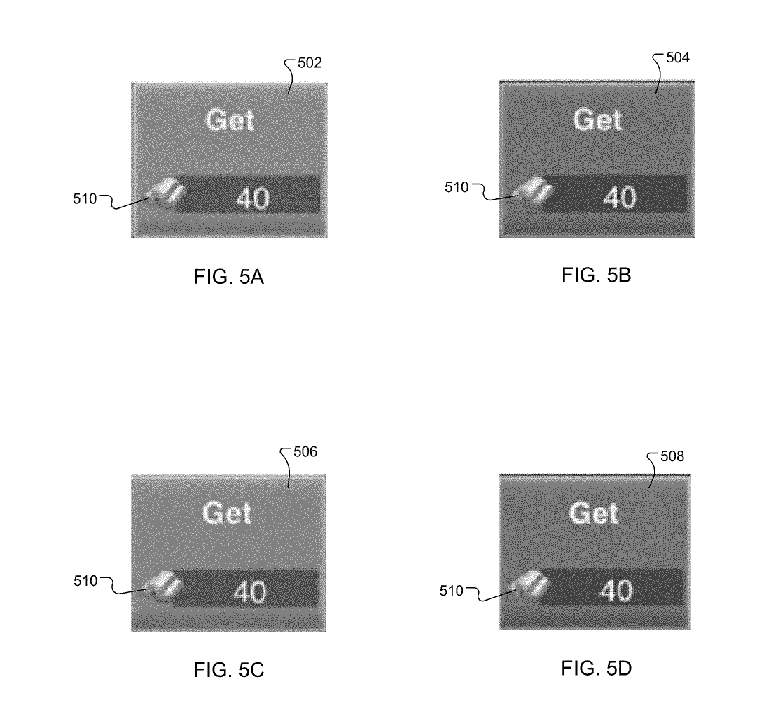

FIGS. 5A, 5B, 5C, and 5D present example images that can be derived using the systems and methods described herein. FIG. 5A includes an original image 502 that is mostly green and includes white text. FIG. 5B includes a derived image 504 that was created by shifting the pixel H values in the original image 502 by 90°. The derived image 504 is mostly blue and the white text from the original image 502 has been preserved. FIG. 5C includes a derived image 506 that was created by shifting the pixel H values in the original image 502 by 210°. The derived image 506 is mostly red and the white text from the original image 502 has been preserved. FIG. 5D includes a derived image 508 that was created by reducing the saturation in the original image 502 to 0. The derived image 508 is mostly gray and the white text from the original image 502 has been preserved. Each of these figures includes a separate overlay image 510 depicting a stack of gold bars. The color shifting used to create the derived images 504, 506, and 508 was not applied to the separate overlay image 510.

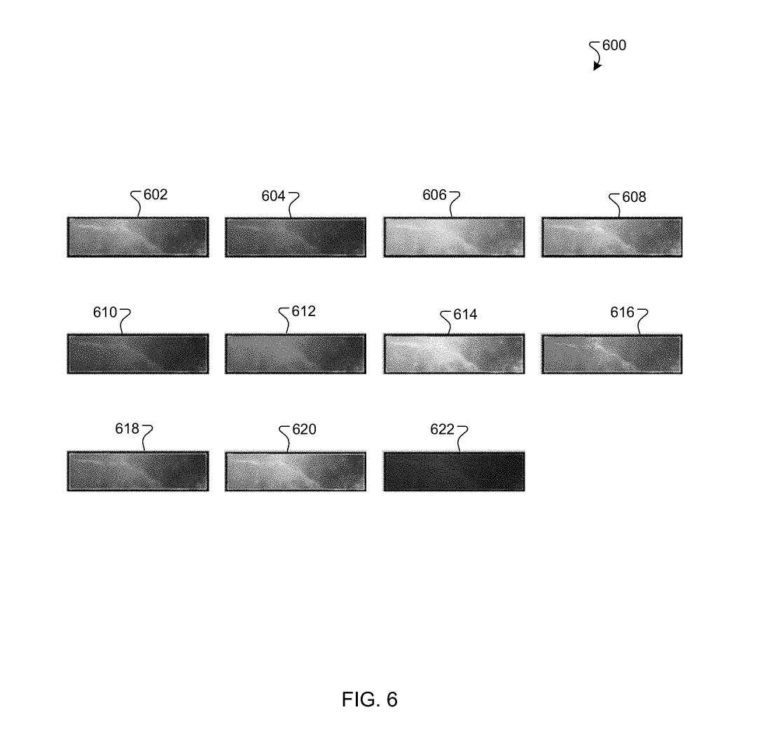

Likewise, FIG. 6 includes a collection of images 600 of different colors that can be derived from an original image 602 using the systems and methods described herein. The original image 602 is primarily green but includes color variation that provides a texture. Derived images 604, 606, 608, 610, 612, 614, 616, 618, 620, and 622 are primarily dark purple, blue-green, light purple, dark blue, dark red, yellow, light red, light blue, gold, and dark gray, respectively. Each derived image can be obtained by performing the color shifting (e.g., in HSV color space) as described herein. Advantageously, these color shifting techniques are able to preserve the texture in each of these images. For example, the gradients in color that provide the texture in the original image 602 can be preserved when colors are shifted in the HSV color space. A shift in H value for all pixels, for example, can change the hue of each pixel in an image but preserve variations in hue (e.g., color gradients) that provide the texture.

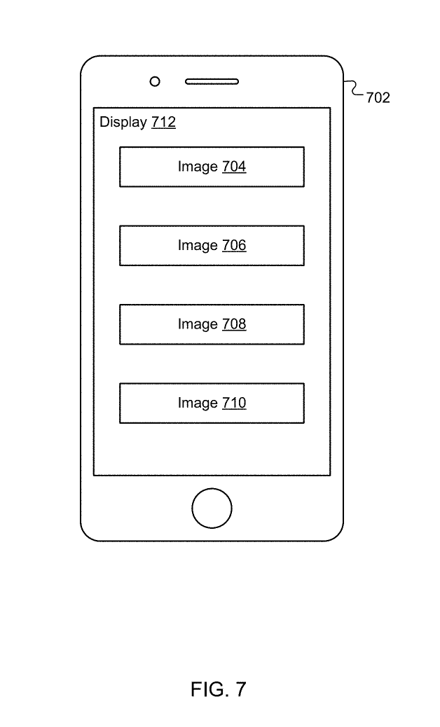

FIG. 7 is a schematic diagram of a client device 702 presenting a collection of images 704, 706, 708, and 710 of different colors on a display 712. In certain examples, the images 704, 706, 708, and 710 can all be derived from an original image using the color shifting techniques described herein. Alternatively or additionally, at least one of the images 704, 706, 708, and 710 can be the original image. The images 704, 706, 708, and 710 can form elements of a graphical user interface for a software application running on the client device 702. For example, the elements can be selected by a user of the client device 702. Alternatively or additionally, the images 704, 706, 708, and 710 or other derived images can form elements displayed in a virtual environment (e.g., for a game), such as virtual characters (e.g., people or animals) or virtual items (e.g., trees, buildings, vehicles, weapons, etc.). In a preferred implementation, the client device 702 is configured to store only the original image and generate derived images as needed. Additionally or alternatively, the client device 702 can receive only the original image from a server (e.g., the server system 112) and the remaining images can be created on the client device. The approach can reduce computer network traffic and/or storage requirements.

In certain examples, the systems and methods described herein can involve converting color to and from HSV color space and performing a color shift in HSV color space. The approach can provide an efficient way to convert and shift RGB colors using HSV values. For example, the systems and methods can be used to provide an efficient shader code for use in OpenGL graphics or the like for shifting the color values of pixels in an image. An example shader code that can be used for this purpose is as follows:

mediump vec3 shift_col(lowp vec3 RGB, mediump vec3 shift)
{

// lowp only guarantees 8 bits of precision, and we are using 3 digit decimal
// values...
const mediump vec3 r00 = vec3( 0.299, 0.299, 0.299);
const mediump vec3 r01 = vec3( 0.701, −0.299, −0.300);
const mediump vec3 r02 = vec3( 0.168, −0.328, 1.250);
const mediump vec3 r10 = vec3( 0.587, 0.587, 0.587); const mediump vec3 r11 =
vec3(−0.587, 0.413, −0.588); const mediump vec3 r12 = vec3(0.330, 0.035, −1.050
);
const mediump vec3 r20 = vec3( 0.114, 0.114, 0.114); const mediump vec3 r21 =
vec3(−0.587, −0.114, 0.886); const mediump vec3 r22 = vec3(−0.497, 0.292, −0.203
);
return ((r00 * shift.z + r01 * shift.x + r02 * shift.y) * RGB.r + (r10 * shift.z + r11
* shift.x + r12 * shift.y) * RGB.g + (r20 * shift.z + r21 * shift.x + r22 * shift.y) *
RGB.b );

} .

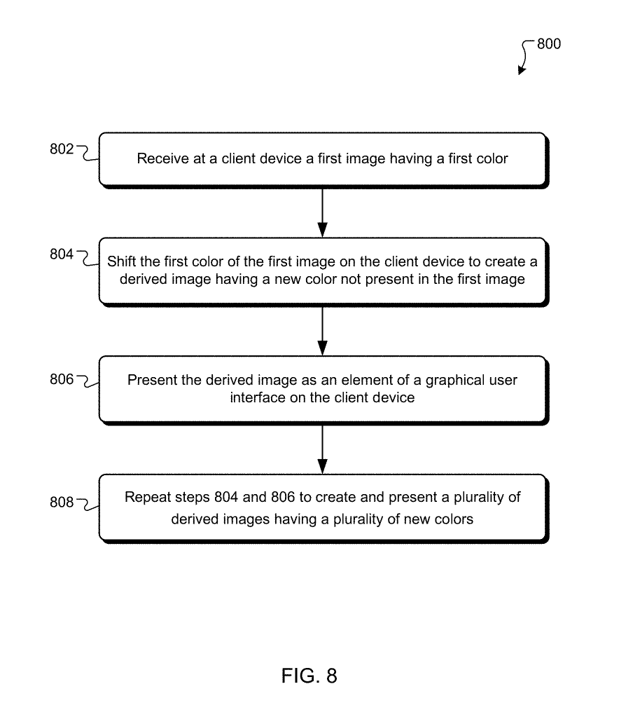

FIG. 8 illustrates an example computer-implemented method 800 of creating images of different colors and presenting the images on a client device. A first image having a first color is received (step 802) at a client device. The first color of the first image is shifted (step 804) on the client device to create a derived image having a new color not present in the first image. The derived image is presented (step 806) as an element of a graphical user interface on the client device. Steps 804 and 806 are repeated (step 808) to create and present a plurality of derived images having a plurality of new colors.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

1. A computer-implemented method, comprising:
(a) receiving at a client device a first image for a graphical user interface, the first image comprising a first color and a texture comprising a gradient in color;
(b) shifting the first color of the first image on the client device to create a derived image comprising a new color not present in the first image;
(c) presenting the derived image as an element of the graphical user interface on the client device; and
(d) repeating steps (b) and (c) to create and present a plurality of derived images comprising a plurality of new colors.

2. (canceled)

3. The method of claim 1, wherein the plurality of derived images comprises the texture.

4. The method of claim 1, wherein shifting the first color comprises:
adjusting at least one of a hue, a saturation, and a value in an HSV color space.

5. The method of claim 1, wherein the first color is defined in an RGB color space, and wherein shifting the first color comprises:
transforming the first color from the RGB color space to an HSV color space.

6. The method of claim 1, wherein shifting the first color comprises:
transforming the new color from an HSV color space to an RGB color space.

7. The method of claim 1, wherein the first image comprises pixels, and wherein shifting the first color comprises:
applying a color shift to a portion of the pixels in the first image.

8. The method of claim 1, wherein the element is selectable by a user of the client device.

9. The method of claim 1,
wherein shifting the first color comprises storing the derived image in memory on the client device, and
wherein presenting the derived image comprises removing the derived image from the memory.

10. The method of claim 1, wherein the first image is received at the client device from a server, and wherein the server provides support for an application used to perform steps (b), (c), and (d) on the client device.

11. A system, comprising:
one or more computer processors programmed to perform operations comprising:
(a) receiving at a client device a first image for a graphical user interface, the first image comprising a first color and a texture comprising a gradient in color;
(b) shifting the first color of the first image on the client device to create a derived image comprising a new color not present in the first image;
(c) presenting the derived image as an element of the graphical user interface on the client device; and
(d) repeating steps (b) and (c) to create and present a plurality of derived images comprising a plurality of new colors.

12. (canceled)

13. The system of claim 11, wherein the plurality of derived images comprises the texture.

14. The system of claim 11, wherein shifting the first color comprises:
adjusting at least one of a hue, a saturation, and a value in an HSV color space.

15. The system of claim 11, wherein the first color is defined in an RGB color space, and wherein shifting the first color comprises:
transforming the first color from the RGB color space to an HSV color space.

16. The system of claim 11, wherein shifting the first color comprises:
transforming the new color from an HSV color space to an RGB color space.

17. The system of claim 11, wherein the first image comprises pixels, and wherein shifting the first color comprises:
applying a color shift to a portion of the pixels in the first image.

18. The system of claim 11, wherein the element is selectable by a user of the client device.

19. The system of claim 11,
wherein shifting the first color comprises storing the derived image in memory on the client device, and
wherein presenting the derived image comprises removing the derived image from the memory.

20. A non-transitory computer-readable medium having instructions stored thereon that, when executed by one or more computer processors, cause the computer processors to perform operations comprising:
(a) receiving at a client device a first image for a graphical user interface, the first image comprising a first color and a texture comprising a gradient in color;
(b) shifting the first color of the first image on the client device to create a derived image comprising a new color not present in the first image;
(c) presenting the derived image as an element of the graphical user interface on the client device; and
(d) repeating steps (b) and (c) to create and present a plurality of derived images comprising a plurality of new colors.
